(19) United States
(12) Patent Application Publication
(10) Pub. No.: US 2009/0111320 A1
(43) Pub. Date: Apr. 30, 2009

(54) ENHANCED UNIVERSAL SERIAL BUS CONNECTOR

(75) Inventors: David Johansson, Malmo (SE); Markus G. Agevik, Malmo (SE); Anders Lundquist, Malmo (SE); Anders Hansson, Klagerup (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/927,872

(22) Filed: Oct. 30, 2007

(51) Int. Cl. H01R 13/58

(52) U.S. Cl. 439/466; 455/566

(57) ABSTRACT

An electrical connector (male and female) that support conventional Universal Serial Bus (USB) signals and includes additional contacts to enable advanced communications and/or functionality between electronic devices and/or accessory devices. In one embodiment, an electrical connector includes a contact support member housed at least partially within a housing. A plurality of first contacts are mounted on a contact support member, wherein each of the plurality of first contacts is configured to electrically connect with the associated connector along a first plane parallel to a plane of insertion for the associated connector into the port. At least one second contact is also mounted on the contact support member, wherein the at least one second contact is configured to electrically connect with the associated connector along a second plane perpendicular to the plane of insertion for the associated connector into the port.

### TECHNICAL FIELD OF THE INVENTION

The present invention relates to electrical connectors and more particularly to Universal Serial Bus (USB) connectors.

### DESCRIPTION OF THE RELATED ART

Today it is commonplace for electronic equipment, such as, for example, communication devices, mobile phones, personal digital assistants, personal computers, digital video recorders, digital camcorders, digital cameras, computer peripheral devices, etc. to include a Universal Serial Bus (USB). USB is a serial bus standard to interface devices through a standardized interface port to improve plug-and-play capabilities by allowing devices to be connected and disconnected without rebooting the computer. Other convenient features associated with USB include powering low-consumption devices without the need for an external power supply and allowing some devices to be used without requiring individual device drivers to be installed.

The implementation of USB is generally in the form of male and female USB connectors, which are commonly employed in electronic equipment. A conventional USB female connector includes four or five signal contacts depending on the type of USB connector. The signals generally provided on a conventional USB connector include +5 Volts, Ground, Data − and Data +. If a fifth connector is provided on the USB connector, the signal contact may be used by an attached device to indicate presence of another device. In some embodiments, the fifth connector is simply not connected or held at ground depending on the specific device. Female USB connectors are typically electrically connected to a motherboard. The signal contacts of the female connector engage with the male connector, thereby transmitting signals through the cable and the mother board for communication between the motherboard and the peripheral device.

### SUMMARY

One drawback associated with conventional USB connectors is that functionality is limited based on the limited number of signal contacts (e.g., four or five) that are available for use between a device and an accessory. For example, it may be desirable to power accessories that require additional power (and/or current) than that allowed by a conventional USB connector. In addition, it may be desirable to output additional signals (other than conventional USB signals) through the USB connector. For example, it may desirable for an accessory device to receive an analog audio output signal through the USB connector. The limited functionality of conventional USB connectors is insufficient to support communications with complex electronic equipment, such as mobile telephones, computers and/or other peripheral devices.

In view of the aforementioned shortcomings associated with conventional USB connectors, there is a need in the art for electrical connectors that support conventional USB signals and has additional contacts to enable advanced communications and/or functionality between electronic devices. Such electrical connectors will provide increased functionality and, at the same time, be fully backwards compatible with conventional USB connectors.

One aspect of the invention relates to an electrical connector including: a housing for receiving an associated connector; wherein the housing includes at least one wall that defines a port having a predetermined configuration; a contact support member housed at least partially within the housing, wherein the contact support member extends forwardly toward the port; a plurality of first contacts mounted on the contact support member, wherein each of the plurality of first contacts is configured to electrically connect with the associated connector along a first plane parallel to a plane of insertion for the associated connector into the port; and at least one second contact mounted on the contact support member, wherein the at least one second contact is configured to electrically connect with the associated connector along a second plane perpendicular to the plane of insertion for the associated connector into the port.

Another aspect of the invention relates to including a printed circuit board for coupling the plurality of first contacts and the at least one second contact to a controller.

Another aspect of the invention relates to the plurality of first contacts and the at least one second contact are secured on the printed circuit board independently of one another.

Another aspect of the invention relates to the at least one second contact has a population of second contacts that is greater than a population of the plurality of first contacts.

Another aspect of the invention relates to the at least one second contact has a plurality of second contacts having a population of second contacts less then a population of the plurality of first contacts.

Another aspect of the invention relates to the plurality of first contacts including a contact for a data + signal contact, a data − signal contact, a ground signal contact and a +5 Volt signal contact.

Another aspect of the invention relates to the at least one second contact include at least one audio signal contact for outputting an analog audio signal to an associated accessory.

Another aspect of the invention relates to the at least one second contact includes at least one power signal contact for outputting a power signal to an associated accessory.

Another aspect of the invention relates to the port being configured to receive at least universal serial bus (USB) connector having a form factor consisting of at least one of a standard USB connector, a mini-USB connector or a micro-USB connector.

Another aspect of the invention relates to at least one contact from the plurality of first contacts and/or the at least one second contacts being formed in the contact support member.

One aspect of the invention relates to an electrical connector including: an interface housing adapted to be inserted into an associated receiving connector; wherein the interface housing includes at least one wall that defines a port having a predetermined configuration; a first contact support member housed at least partially within the interface housing, wherein the first contact support member extends forwardly toward the port; a plurality of first contacts mounted on the first contact support member, wherein each of the plurality of first contacts is configured to electrically connect with the associated connector along a plane parallel to a plane of insertion of the interface housing into the associated receiving connector the port; and at least one second contact mounted within the interface housing, wherein the at least one second contact is configured to electrically connect with the associated connector along a second plane perpendicular to the axis of insertion of the interface housing into the associated receiving connector.

Another aspect of the invention relates to including an accessory housing secured to the interface housing, wherein the accessory housing includes accessory circuitry for performing a communication function.

Another aspect of the invention relates to a printed circuit board for coupling the plurality of first contacts and the at least one second contact to accessory circuitry housed at least partially within the accessory housing.

Another aspect of the invention relates to an elastic member coupled between the at least one second contact and the printed circuit board to allow the at least one second contact to extend and/or retract within the interface housing.

Another aspect of the invention relates to the elastic member being a spring.

Another aspect of the invention relates to the plurality of first contacts and the at least one second contact include one end secured on the printed circuit board independently of one another.

Another aspect of the invention relates to the at least one second contact has a population of second contacts that is greater than a population of the plurality of first contacts.

Another aspect of the invention relates to the at least one second contact has a population of second contacts that is less than a population of the plurality of first contacts.

Another aspect of the invention relates to the plurality of first contacts include a contact for a data + signal contact, a data − signal contact, a ground signal contact and a +5 Volt signal contact.

Another aspect of the invention relates to the port is configured to be inserted into a universal serial bus (USB) connector having a form factor consisting of at least one of a standard USB connector, a mini-USB connector or a micro-USB connector.

One aspect of the invention relates to a mobile telephone including: a housing; communication circuitry for receiving and/or transmitting telephone calls over a mobile telephony network housed within the housing; an electrical connector as described in claim 1 housed within at least a portion of the housing, wherein the port is capable of receiving a connector from the associated accessory; and control circuitry coupled to communication circuitry and the electrical connector to control operation of the communication circuitry and the electrical connector to perform one more functions.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is an exemplary electronic device and accessory device in accordance with aspects of the present invention.

FIG. 2 is a functional block diagram of the electronic device and accessory device illustrated in FIG. 1.

FIG. 3 is a front cross-sectional view of an exemplary female electrical connector in accordance with aspects of the present invention.

FIG. 4 is a side cross-sectional view of the exemplary female electrical connector, shown in FIG. 3.

FIGS. 5-7 are front cross-sectional views of exemplary female electrical connectors in accordance with aspects of the present invention.

FIG. 8 is a functional block diagram in accordance with aspects of the present invention.

FIG. 9 is a front cross-sectional view of an exemplary male electrical connector in accordance with aspects of the present invention.

FIG. 10 is a side cross-sectional view of the exemplary male electrical connector, shown in FIG. 9.

FIGS. 11-13 are front cross-sectional views of exemplary male electrical connectors in accordance with aspects of the present invention.

FIG. 14 is a functional block diagram in accordance with aspects of the present invention.

FIG. 15 is a side cross-sectional view of exemplary male and female electrical connectors electrically connected in accordance with aspects of the present invention.

### DETAILED DESCRIPTION OF EMBODIMENTS

The present invention is directed to Universal Serial Bus (USB) connectors that are suitable for use in a wide variety of electronic equipment (e.g., communication devices, mobile telephones, personal digital assistants, personal computers, digital video recorders, digital camcorders, digital cameras, computer peripheral devices, etc.). Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment, personal computers, digital video recorders, digital camcorders, digital cameras, computer peripheral devices, etc.). The term “portable radio communication equipment,” which hereinafter is referred to as a “mobile radio terminal,” includes all equipment such as mobile telephones, pagers, communicators, electronic organizers, personal digital assistants (PDAs), smart phones, portable communication apparatus, portable gaming devices, portable media devices (video and/or audio), and the like.

In the present application, embodiments of the invention are described primarily in the context of a mobile telephone. However, it will be appreciated that the invention is not intended to be limited to the context of a mobile telephone and may relate to any type of electronic equipment.

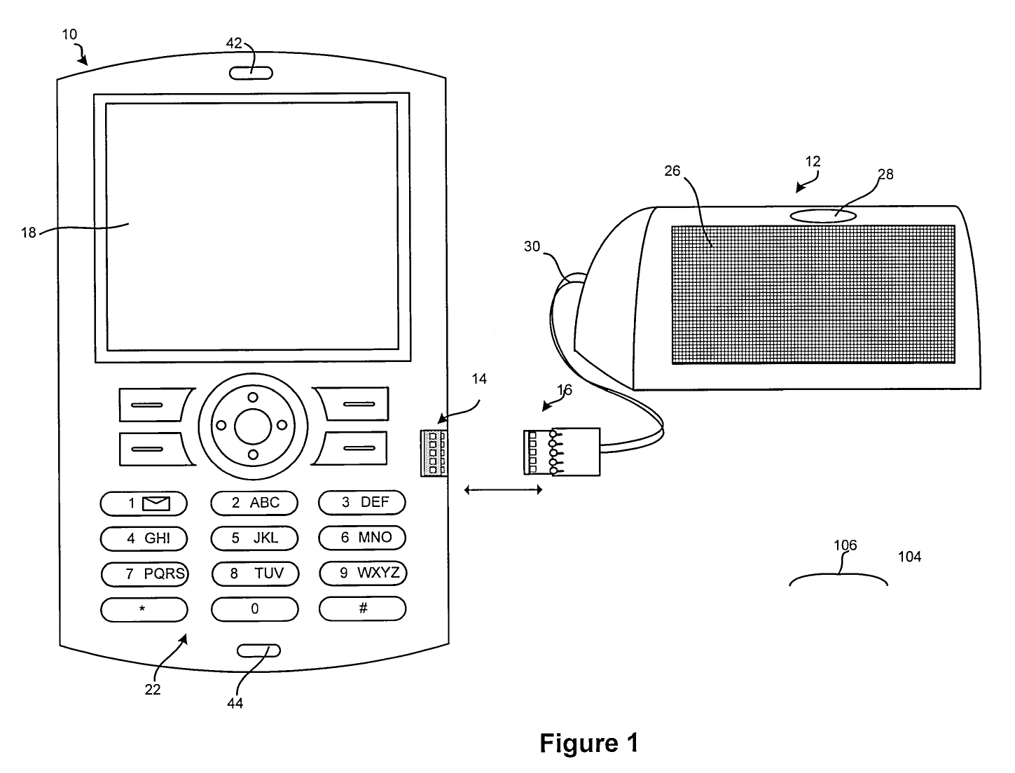

Referring initially to FIGS. 1 and 2, an electronic device 10 and an accessory device 12 are shown. The electronic device 10 includes a female electrical connector 14 for receiving a male electrical connector 16 for coupling the electronic device 10 with the accessory device 12. As described more fully below, the electronic connectors 12 and 14 are configured to include one or more additional electrical contacts than conventional Universal Serial Bus (USB) connectors. The connectors 12 and 14 generally include a plurality of first contacts, which are configured to communicate with conventional USB connectors. The connectors 12 and 14 also include at least one second contact to provide additional signals to an accessory device. Generally, the first contacts are aligned together along a first contact plane that is substantially coplanar with the plane of insertion of the male connector 16 into the female connector 14. The one or more second contacts are generally aligned together along a second contact plane that is perpendicular to and/or offset from the first contact plane and/or the plane of insertion. The one or more additional contacts permit increased functionality over conventional USB connectors. For example, it may be desirable to power accessory devices that require more power and/or current than permitted to be output on a conventional USB connector; it may also be desirable to output an analog audio output signal, a video signal or additional data channels, through the USB connector for use by the accessory device 12 or other suitable device.

The electronic device 10 of the illustrated embodiment is a mobile telephone and will be referred to as the mobile telephone 10. The mobile telephone 10 is shown as having a brick or block form factor, although other form factors, such as a “flip-open” form factor (e.g., a “clamshell” housing) or a slide-type form factor (e.g., a “slider” housing) also my be utilized.

The mobile telephone 10 may include a display 18. The display 18 displays information to a user such as operating state, time, telephone numbers, contact information, various navigational menus, etc., which enable the user to utilize the various features of the mobile telephone 10. The display 18 also may be used to visually display content received by the mobile telephone 10 and/or retrieved from a memory 20 (FIG. 2) of the mobile telephone 10. The display 18 may be used to present images, video and other graphics to the user, such as photographs, mobile television content and video associated with games.

A keypad 22 provides for a variety of user input operations. For example, the keypad 22 typically includes alphanumeric keys for allowing entry of alphanumeric information such as telephone numbers, phone lists, contact information, notes, etc. In addition, the keypad 22 typically includes special function keys such as a “call send” key for initiating or answering a call, and a “call end” key for ending or “hanging up” a call. Special function keys also may include menu navigation and select keys to facilitate navigating through a menu displayed on the display 18. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone 10 may include a volume key, an audio mute key, an on/off power key, a web browser launch key, a camera key, etc. Keys or key-like functionality also may be embodied as a touch screen associated with the display 18. Also, the display 18 and keypad 22 may be used in conjunction with one another to implement soft key functionality.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VOIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc.

The mobile telephone 10 may be configured to transmit, receive and/or process data, such as text messages (e.g., a text message is commonly referred to by some as “an SMS,” which stands for short message service), instant messages, electronic mail messages, multimedia messages (e.g., a multimedia message is commonly referred to by some as “an MMS,” which stands for multimedia message service), image files, video files, audio files, ring tones, streaming audio, streaming video, data feeds (including podcasts) and so forth. Processing such data may include storing the data in the memory 20, executing applications to allow user interaction with data, displaying video and/or image content associated with the data, outputting audio sounds associated with the data and so forth.

The accessory device 12 illustrated in FIG. 1 may be any desired accessory. For example, the accessory device may be a hands-free accessory (as shown in FIG. 1), the accessory device may be a headset, a keypad, a speaker, a wireless adapter (e.g., IEEE 802.11 communication adapter, infrared adapter, radio frequency identification adapter, near field communication adapter, etc.) to provide increased wireless functionality to the mobile telephone 10, computer, computer peripherals, etc. As shown in FIG. 1, the accessory device 12 is a hands-free accessory that provides a speaker 26 to output audio signals from the mobile telephone 12 and a microphone 28 that captures audio signals and transfers the audio signals to the mobile telephone 10. As shown in FIG. 1, a cable 30 is generally provided to couple the accessory device 12 to the mobile telephone 10. As explained below, the cable 30 includes an electrical connector 16 that matingly engages with electrical connecter 14 of the mobile telephone 10 to accomplish the functionality described herein. One of ordinary skill in the art will readily appreciate that a wireless adapter configured in a similar manner as connector 16 may also provide the desired functionality.

FIG. 2 represents a functional block diagram of the mobile telephone 10 and the accessory device 12. For the sake of brevity, generally conventional features of the mobile telephone 10 and the accessory device 12 will not be described in great detail herein. The mobile telephone 10 includes a primary control circuit 32 that is configured to carry out overall control of the functions and operations of the mobile telephone 10. The control circuit 32 may include a processing device 34, such as a CPU, microcontroller or microprocessor. The processing device 34 executes code stored in a memory (not shown) within the control circuit 32 and/or in a separate memory, such as the memory 20, in order to carry out operation of the mobile telephone 10.

The memory 20 may include a read only memory area that is implemented using nonvolatile memory 20a, and a random access or system memory area that is implemented using volatile memory 20b. As will be appreciated, nonvolatile memory tends not to lose data storage capability upon loss of power and is typically used to store data, application code, files and so forth. The nonvolatile memory 20a may be implemented with a flash memory, for example. As will be appreciated, volatile memory tends to lose data storage capability upon loss of power and is typically used to store data for access by the processing device 34 during the execution of logical routines. The volatile memory 20b may be a random access memory (RAM). Data may be exchanged between the nonvolatile memory 20a and the volatile memory 20b as is conventional. The nonvolatile memory 20a and the volatile memory 20b may be sized as is appropriate for the mobile telephone 10 or other electronic device in which the memory 20 is used.

Continuing to refer to FIGS. 1 and 2, the mobile telephone 10 includes an antenna 36 coupled to a radio circuit 38. The radio circuit 38 includes a radio frequency transmitter and receiver for transmitting and receiving signals via the antenna 36 as is conventional. The radio circuit 38 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 40 for processing audio signals transmitted by and received from the radio circuit 38. Coupled to the sound processing circuit 40 are a speaker 42 and a microphone 44 that enable a user to listen and speak via the mobile telephone 10 as is conventional. The radio circuit 38 and sound processing circuit 40 are each coupled to the control circuit 32 so as to carry out overall operation. Audio data may be passed from the control circuit 32 to the sound signal processing circuit 40 for playback to the user. The audio data may include, for example, audio data from an audio file stored by the memory 20 and retrieved by the control circuit 32, or received audio data such as in the form of streaming audio data from a mobile radio service. The sound processing circuit 40 may include any appropriate buffers, decoders, amplifiers and so forth.

The display 18 may be coupled to the control circuit 32 by a video processing circuit 46 that converts video data to a video signal used to drive the display 18. The video processing circuit 46 may include any appropriate buffers, decoders, video data processors and so forth. The video data may be generated by the control circuit 32, retrieved from a video file that is stored in the memory 20, derived from an incoming video data stream that is received by the radio circuit 38 or obtained by any other suitable method.

The mobile telephone 10 may further include one or more I/O interface(s) 48. The I/O interface(s) 48 may be in the form of typical mobile telephone I/O interfaces and may include one or more electrical connectors. As is typical, the I/O interface(s) 48 may be used to couple the mobile telephone 10 to a battery charger to charge a battery of a power supply unit (PSU) 50 within the mobile telephone 10. In addition, or in the alternative, the I/O interface(s) 48 may serve to connect the mobile telephone 10 to a headset assembly (e.g., a personal hands free (PHF) device) that has a wired interface with the mobile telephone 10. Further, the I/O interface(s) 48 may serve to connect the mobile telephone 10 to an accessory device, a personal computer, computer peripheral or any other electronic device via a data cable for the exchange of data (e.g., via the electrical connecter 14) and/or through a wireless adapter (not shown) that may be connected to the electrical connector 14. Additionally, the mobile telephone 10 may receive operating power via the I/O interface(s) 48 when connected to a vehicle power adapter or an electricity outlet power adapter.

The mobile telephone 10 also may include a system clock 52 for clocking the various components of the mobile telephone 10, such as the control circuit 32. The control circuit 32 may, in turn, carry out timing functions, such as timing the durations of calls, generating the content of time and date stamps, and so forth.

Referring now to the exemplary accessory device 12, the accessory device 12 includes a primary control circuit 52 that is configured to carry out overall control of the functions and operations of the accessory device 12. The control circuit 52 may include a processing device 54, such as a CPU, microcontroller or microprocessor. The processing device 54 executes code stored in a memory (not shown) within the control circuit 52 and/or in a separate memory (not shown), in order to carry out operation of the accessory device 12. The memory may be, for example, a buffer, a flash memory, a hard drive, a removable media, a volatile memory and/or a non-volatile memory. In addition, the processing device 54 executes code to carry out various functions of the accessory device 12.

The accessory device 12 includes an input/output interface adapter 56, which is shown coupled to a data cable 30 having electrical connector 16 attached on a free end for coupling to the mobile telephone 10 through electrical connector 14. The input/output interface adapter 56 generally serves to connect the accessory device 12 with the mobile telephone 10. As one of ordinary skill in the art will readily appreciate, the cable 30 leading from the electrical connector 16 to the accessory may be omitted if the accessory connected to the connector 16 includes a wireless adapter that may be coupled to the electrical connector 14 through electrical connector 16.

The accessory device 12 further includes an audio data processing device 58 that manages audio data. For example, the audio data processing device 58 may include an encoder 60 that encodes an audio signal received from a microphone 28. Encoded audio data may be transmitted to the mobile telephone 10 for use as part of a telephone call. In addition, the audio data processing device 58 may include a decoder 62 and a data buffer 64 to process audio data received from the mobile telephone 10 and/or one or more devices associated with a network.

The received audio data may be incoming audio data associated with a telephone call. In other situations, the audio data received by the accessory device 12 may be audio (e.g., music, sound, voice, etc.) derived from an audio file played back by the mobile telephone 10. The audio data may be associated with video content displayed on the display 18 of the mobile telephone 12. For example, a video file containing an audio component stored in the memory 20 may be rendered by the mobile telephone 12. In such situations, the video component of the video file or received video signal may be decoded by, for example, the control circuit 32 of the mobile telephone 10 or dedicated video decoder (not shown) to generate a video signal output to the display 18 for viewing. The audio component of the video file or received video signal may be decoded and delivered as an audio signal to the speaker 42 and/or the audio component may be transmitted as audio data to the accessory device 14 for decoding into an audio signal that is broadcast by the speaker 26.

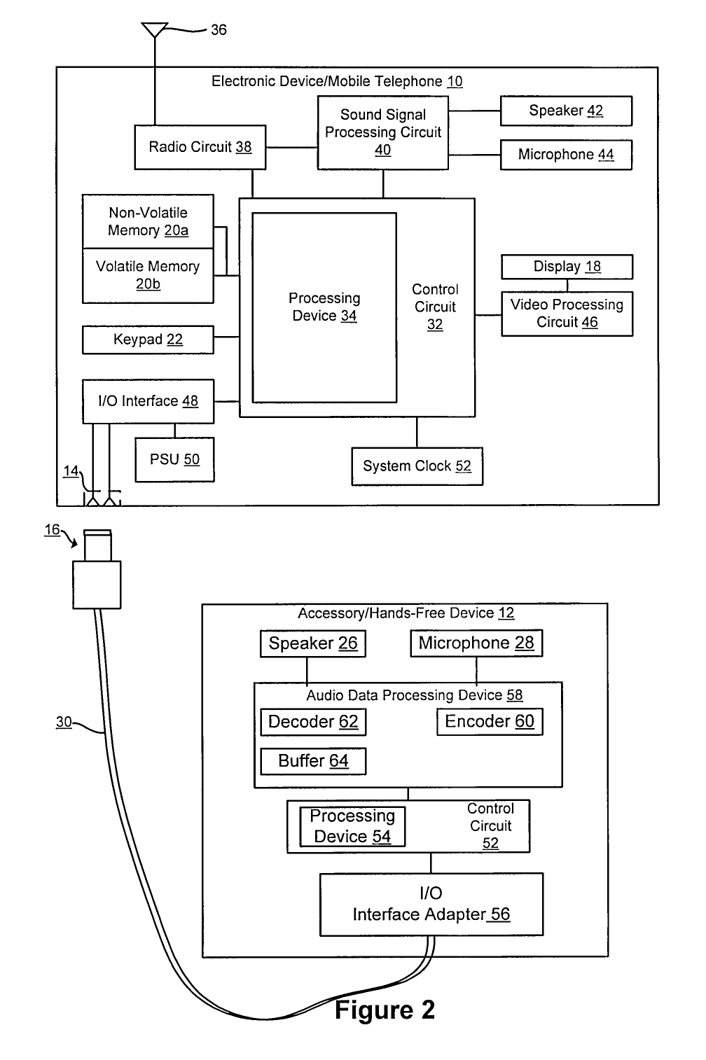

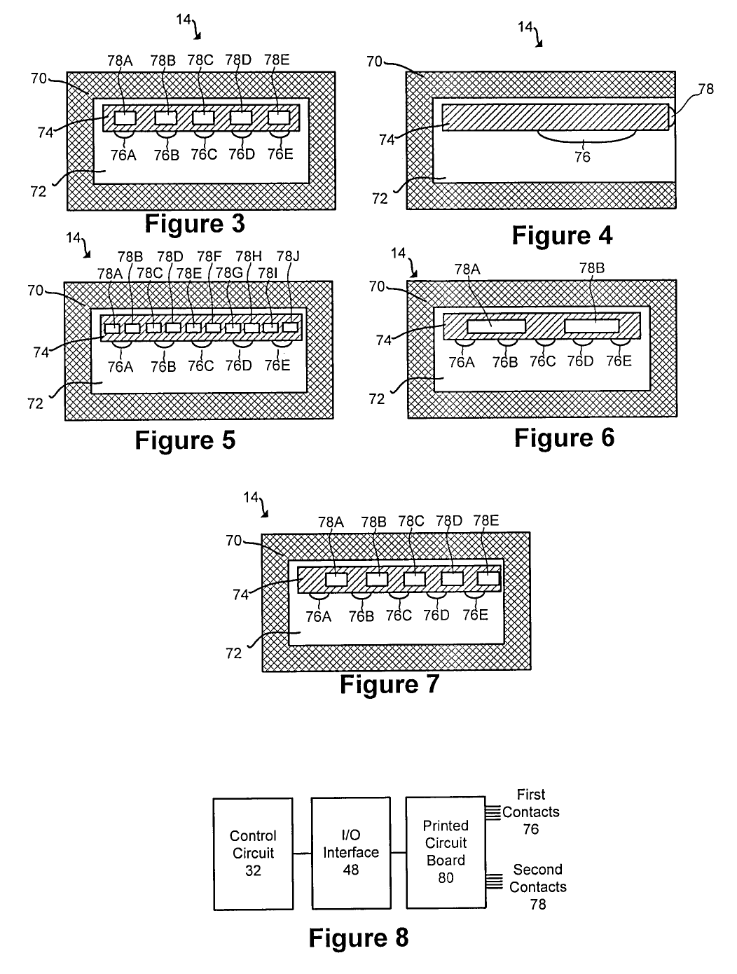

Moving now to FIGS. 3 and 4, an exemplary electrical connector 14 in accordance with aspects of the invention is shown. The electrical connector 14 includes a housing 70 for receiving an associated connector from an accessory device. The housing is generally formed from at least one wall that defines a port 72 having a predetermined configuration. The port 72 may take any desired form. As shown in FIG. 3, the port 72 may be rectangular in form. The housing 70 may include one more alignment guides (not shown) that generally prevent a connector not having a predetermined shape to enter into the port 72. In addition, the alignment guides ensure proper alignment of the associated connector with the electrical connector 14. The housing 70 may be made of any desirable material. Conventional housing materials include, for example, metal, plastic and the like.

The electrical connector 14 includes a contact support member 74, which is housed at least partially within the housing 70. The contact support member 74 generally extends forwardly toward the opening of the port 72. The contact support member 74 is generally made of an insulator material. Any insulator material may be used in accordance with aspects of the present invention. Exemplary insulator materials include rubber, plastic, etc.

The contact support member 74 has a plurality of first contacts 76 (e.g., 76A-76E) mounted on and/or formed in the contact support member 76. Each of the plurality of first contacts 76 is configured to electrically connect with the associated connector along a plane substantially parallel to a plane of insertion associated with the associated connector into the port 72.

The plurality of first contacts 76 is generally configured to accept conventional USB connectors (e.g., standard USB connectors, mini-USB connectors, micro-USB connectors, etc. As such, the signals generally provided on the plurality of first contacts 76 included, for example, +5 Volts on contact 76A, Data minus on contact 76B, Data plus on contact 76C, and ground on contact 76D. If a fifth contact (e.g., contact 76E) is provided on the connector, the signal contact may be used by an attached device to indicate presence of another device (e.g., mobile telephone 10). In some embodiments, the fifth connector is simply not connected or held at ground depending on the device. Additional contacts may be provided adjacent the plurality of first contacts 76.

As shown in FIG. 3, the plurality of first contacts 76 are provided in a linear distribution having a substantially equidistant spacing between each of the contacts. One or ordinary skill in the art will readily appreciate that the contacts may be configured and/or spaced in any desired configuration. Such configurations include, for example, non equidistant, offset, non-linear, etc.

The plurality of first contacts 76 generally extend outward from the contact support member 74 in order to engage corresponding contacts from an accessory device in order to establish signaling and/or communication paths between the mobile telephone 10 and the accessory device 12. The contacts may have any desirable shape. For example, the contacts may be curved, hemispherical, pointed, rectangular, etc.

The contact support member 74 further includes one or more second contacts 78 (e.g., 78A-78E) mounted on and/or formed in the contact support member 74. In many cases, it will be desirable to have one or more additional second contacts 78 for increased functionality, efficiency, etc. Accordingly, the specification will generally refer to multiple contacts for the sake of brevity. Each of the second contacts 78 is configured to electrically connect with an associated connector from an accessory device along an axis perpendicular to the axis of insertion for the associated connector. The second contacts 78 may be configured to accept any desirable signal available within the mobile telephone 10 depending on the type of accessory and/or receive any desired signal from the accessory device 12. For example, due to power limitations associated with conventional USB connectors, only a limited current may be output from a conventional USB connector. However, if additional power contacts are provided in the set of second contacts, additional current may be provided to power an accessory device (e.g., a speaker) through the electrical connector 14. In addition, if an analog audio output signal is configured to be output on at least one contact of the plurality of second contacts, the electrical connector provides increased functionality over conventional USB connectors by allowing an accessory device, with an appropriate electrical connector, to make use of the analog audio output signal through the electrical connector 14. Other exemplary signals may include data channels, video, etc.

Referring to FIGS. 3 and 4, the plurality of first contacts 76 may be distributed on a first face of the contact support member 74 and the second contacts 78 may be distributed on a second face of the contact support member 74. In one embodiment, the first face and the second face are oriented substantially perpendicular to each other. One of ordinary skill in the art will readily appreciate that additional orientations (e.g., 45°, 30°, 135°, etc.) are also within the scope of the present invention and may be desirable depending on such items, as the type of electrical device, type of accessory, the application, environment, etc.

As shown in FIG. 3, the second contacts 78 (e.g., 78A-78E) are provided in a linear distribution having a substantially equidistant spacing between each of the contacts. One or ordinary skill in the art will readily appreciate that the second contacts 78 may be configured and/or spaced in any desired configuration. Such configurations include, for example, non-equidistant, offset, non-linear, etc.

As shown in FIG. 3, the plurality of first contacts 76 may have the same number of contacts as the number of second contacts 78. In addition, the number of second contacts 78 may be more (e.g., a higher population) than the plurality of first contacts 76, as shown in FIG. 5. Alternatively, the number of second contacts 78 may have fewer contacts (e.g., a lower population) than the plurality of first contacts 76, as shown in FIG. 6. The plurality of first contacts 76 may be aligned with the plurality of second contacts 78, as shown in FIG. 3. The plurality of first contacts 76 may also be offset from the second contacts 78, as shown in FIG. 7.

Referring to FIG. 8, the contacts associated with the plurality of first contacts 76 and the second contacts are typically configured on a printed circuit board 80 electrically independent of one another. Alternatively, one or more signals of the plurality of first contacts and/or plurality of second contacts may be coupled to together. That is, if desired, one or more first contacts 76 and/or second contacts 78 may be electrically coupled together. Likewise, multiple second contacts 78 may be electrical coupled together. The printed circuit board 80 may be coupled to the input/output interface 48 that is coupled to the control circuit 32 (also referred to as a controller), as shown in FIG. 8.

Due to the configuration of the electrical connector 14, a conventional USB male connector may be matingly inserted into the port 72. The conventional USB male connector will generally engage with the plurality of first contacts 76. Since a conventional USB male connector generally does not have contacts that correspond to the contacts provided by the second contacts 78, the electrical connector 14 is fully compatible with conventional USB connectors. Hardware designers may take advantage of this functionality by designing one mode of operation when the electrical connector 14 is connected to conventional USB connectors, as well as, a second mode of operation (having enhanced functionality) for an accessory device that is configured to include contacts that correspond to the second contacts 78.

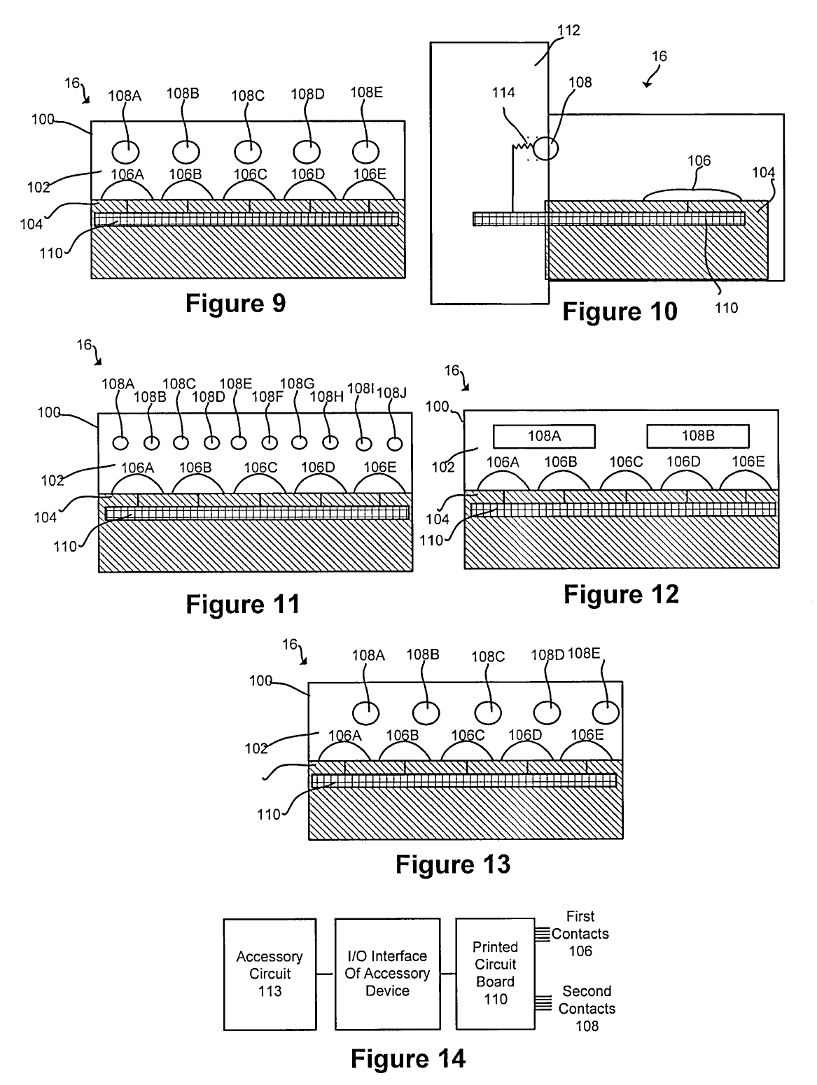

Referring to FIGS. 9 and 10, an exemplary electrical connector 16 is illustrated. Electrical connector 16 insertably mates with electrical connector 14 to form a secure communication link between the mobile telephone 10 and the accessory device 12.

The electrical connector 16 includes an interface housing 100 that is insertable into an associated connector from an electronic device (e.g., mobile telephone 10). The interface housing 100 is generally formed from at least one wall that defines a port 102 having a predetermined configuration. The port 102 may take any desired form. As shown in FIG. 9, the port 102 may be rectangular in form. The port 102 is generally formed to be matingly inserted into a female connector (e.g., electrical connector 14). The interface housing 100 may include one more alignment guides (not shown) that generally prevent a connector not having a predetermined shape to be inserted into a non-conforming female port. In addition, the alignment guides ensure proper alignment of the associated connector with the electrical connector 16 with a corresponding receiving port. The housing 100 may be made of any desirable material (e.g., metal, plastic etc.).

The contact support member 104 is housed at least partially within the interface housing 100, as shown in FIG. 10. The contact support member 104 generally extends forwardly toward the opening of the port 102. The contact support member 104 is generally made of an insulator material. Any insulator material may be used in accordance with aspects of the present invention. Exemplary insulator materials include rubber, plastic, etc.

The contact support member 104 has a plurality of first contacts 106 (e.g., 106A-106E) mounted on and/or formed in the contact support member 104. Each of the plurality of first contacts 104 is configured to electrically connect with the associated connector along a plane that is substantially parallel to an axis of insertion of the interface housing 100, as illustrated in FIG. 10. The plurality of first contacts 106 is generally configured to be inserted into a conventional female USB connectors (e.g., standard USB connectors, mini-USB connectors, micro-USB connectors, etc.) depending on the form size of the housing 100. As such, the signals generally provided on the plurality of first contacts 106 include, for example, +5 Volts on contact 106A, Data minus on contact 106B, Data plus on contact 106C, and ground on contact 106D. If a fifth contact (e.g., contact 106E) is provided on the connector, the signal contact may be used by an attached device to indicate presence of another device (e.g., mobile telephone 10). In some embodiments, the fifth connector is simply not connected or held at ground depending on the device. Additional contacts may be provided adjacent the plurality of first contacts 106.

As shown in FIG. 9, the plurality of first contacts 106 are provided in a linear distribution having a substantially equidistant spacing between each of the contacts. One or ordinary skill in the art will readily appreciate that the contacts may be configured and/or spaced in any desired configuration. Such configurations include, for example, non-equidistant, offset, non-linear, etc.

The plurality of first contacts 106 generally extend outward from the contact support member 104 in order to engage corresponding contacts from a female connector, such as electrical connector 14 in order to establish signaling and/or communication paths between the mobile telephone 10 and the accessory device 12. The contacts may have any desirable shape. For example, the contacts may be curved, hemispherical, pointed, rectangular, etc.

The electrical connector 16 further includes at least one second contact 108 mounted within the interface housing. One of ordinary skill in the art will readily appreciate that aspects of the invention may be carried out with single additional contact. In many cases, it will desirable to have more than one additional contact 108. Accordingly, aspects of the invention will be described as having multiple second contacts 108. The second contacts 108 are configured to be electrically connected with the associated connector along a plane that is perpendicular to the plane of insertion of the interface housing into a corresponding electrical connector 14.

The second contacts 108 may be configured to accept any desirable signal available within the mobile telephone 10 and transmit any desired signal from the accessory device 12 to the mobile telephone 10 (or other electronic devices). For example, one or more of the second contacts 108 may receive additional power signals from electrical connector 14, which is associated with an electronic device to support functionality of a particular accessory device. For example, if accessory device 12 is a hands-free kit, and/or speaker, additional current (over that provided by a conventional USB connector) can be provided through one or more of the second contacts 108. As another example, accessory device 12 may be configured to receive an analog audio output that is configured to be output on at least one of the second contact 108. Thus, the second contacts 108 cooperate with second contacts 76 on the mobile telephone to provide additional functionality to the mobile telephone 10 and the accessory device 12.

Referring to FIGS. 9 and 10, the plurality of first contacts 106 may be distributed on a face of the contact support member 104. The one or more second contacts may be secured at near the distal end of the port 102 in any desired manner. For example, the second contacts 108 may be secured to the accessory housing 112, to the contact support member or any other structure contained within the electrical connector 16. The plurality of first contacts 106 and the second contacts are oriented substantially perpendicular to each other. One of ordinary skill in the art will readily appreciate that additional orientations (e.g., 45°, 30°, 135°, etc.) are also within the scope of the present invention. Generally, the plurality of first contacts 106 are configured to make electrical contact with corresponding first contacts 76 in the electrical connector 14 when inserted in port 72. Likewise, the second contacts 108 are configured to make electrical contact with corresponding first contact 76 in the electrical connector 14 when inserted in port 72.

As shown in FIG. 9, the second contacts 108 (e.g., 108A-108E) are provided in a linear distribution having a substantially equidistant spacing between each of the contacts. One or ordinary skill in the art will readily appreciate that the plurality of second contacts 108 may be configured and/or spaced in any desired configuration. Such configurations include, for example, non-equidistant, offset, non-linear, etc.

The plurality of first contacts 106 may have the same number of contacts as the plurality of second contacts 108, as shown in FIG. 9. In addition, the second contacts 108 may have more contacts (higher population) than the plurality of first contacts 106, as shown in FIG. 11. Alternatively, the second contacts 108 may have fewer contacts (lower population) than the plurality of first contacts 106, as shown in FIG. 12.

The plurality of first contacts 106 may be aligned with the second contacts 108, as shown in FIG. 9. The plurality of first contacts 106 may also be offset from the plurality of second contacts 108, as shown in FIG. 13.

The contacts associated with the plurality of first contacts 106 and the second contacts generally have at least one end secured on a printed circuit board 110 electrically independent of one another. Alternatively, one or more signals of the plurality of first contacts 106 and/or the second contacts may be coupled to together, as desired. The printed circuit board 110 may be coupled to the accessory circuitry 113 that makes use and/or otherwise manipulates the signals received through the plurality of first contacts 106 and/or the second contacts 108 to provide the desired functionality of the accessory device 12.

Referring to FIG. 10, the one or more second contacts 108 may include an elastic member 114 (e.g., a spring, coil, etc.) coupled between second contacts 108 and the printed circuit board 110. The elastic member 114 exerts a force on the second contacts 108 to urge contact with a corresponding second contact 18 from an associated female connector (e.g., electrical connector 14). Also, the elastic member 114 allows for the second contacts 108 to retreat within the housing 100 and/or accessory housing 112 when the electric connector 16 is inserted into a female connector that does not include corresponding contacts to engage with second contacts 108. This allows the electrical connecter 16 to be inserted into a conventional USB female connector (e.g., a standard USB connector, a mini-USB connector, a micro-USB connector, etc.) without the second contacts 108 interfering and/or otherwise hindering securement of the connectors.

When inserted into the conventional USB female connector, the second contacts 108 will retreat into the housing 100 and not interfere with insertion of the electrical connecter 16 into the conventional USB female connector. When inserted into the conventional USB female connector, the electrical connector 16 will generally engage with the conventional USB contacts of the USB female connector. This allows the electrical connector 16 to be fully compatible with conventional USB connectors. Hardware designers may be able to advantage of this by monitoring whether or not second contacts retreat into the housing. If the second contacts retreat into the housing, it known that the electrical connector 16 was plugged in to a conventional USB connector, accordingly less functionality and/or capabilities of the accessory device 12 can be expected. Likewise, if the second contacts are extended, then the second contacts are engaged in an enhanced USB electrical connector (e.g., electrical connector 14) and the accessory device 12 may make use of the full functionality and/or capabilities of the accessory device.

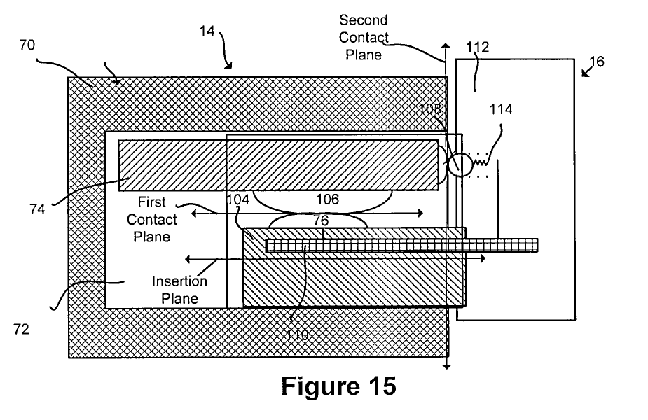

Referring to FIG. 15, female electrical connector 14 is shown electrically engaged with male connector 16. As shown, the first contacts 76 and 106 engage along a first contact plane that is substantially parallel with a plane of insertion. Second contacts 78 and 108 engage along a second plane. The second plane may be substantially perpendicular to the insertion plane, as shown in FIG. 15 or may be non-perpendicular (e.g., offset at angle). One of ordinary skill in the art will readily appreciate that angular variations between the insertion plane, the first contact plane and the second contacts fall within the scope of the present invention. Accordingly, variations between the insertion plane, the first contact plane and the second contact plane fall within the scope of the present invention. For example, the orientation of the second contact plane may be made with respect to the first contact plane, as opposed to the insertion plane.

Referring back to FIG. 1, an exemplary cable 30 is illustrated having a male electrical connector 16. One of ordinary skill in the art will appreciate that the cable 30 may have two free ends that include identical connectors and/or connectors that have the same functionality but different form factors (e.g., a standard USB, mini-USB, micro-USB, etc.).

Specific embodiments of the invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. An electrical connector comprising:
a housing for receiving an associated connector; wherein the housing includes at least one wall that defines a port having a predetermined configuration;
a contact support member housed at least partially within the housing, wherein the contact support member extends forwardly toward the port;
a plurality of first contacts mounted on the contact support member, wherein each of the plurality of first contacts is configured to electrically connect with the associated connector along a first plane parallel to a plane of insertion for the associated connector into the port; and
at least one second contact mounted on the contact support member, wherein the at least one second contact is configured to electrically connect with the associated connector along a second plane perpendicular to the plane of insertion for the associated connector into the port, wherein the first contacts and the at least one second contact are electrically independent of each other.

2. An electrical connector comprising:
a housing for receiving an associated connector; wherein the housing includes at least one wall that defines a port having a predetermined configuration;
a contact support member housed at least partially within the housing, wherein the contact support member extends forwardly toward the port;
a plurality of first contacts mounted on the contact support member, wherein each of the plurality of first contacts is configured to electrically connect with the associated connector along a first plane parallel to a plane of insertion for the associated connector into the port;
at least one second contact mounted on the contact support member, wherein the at least one second contact is configured to electrically connect with the associated connector along a second plane perpendicular to the plane of insertion for the associated connector into the port; and
a printed circuit board for coupling the plurality of first contacts and the at least one second contact to a controller.

3. The electrical connector of claim 2, wherein the plurality of first contacts and the at least one second contact are secured on the printed circuit board independently of one another.

4. An electrical connector comprising:
a housing for receiving an associated connector; wherein the housing includes at least one wall that defines a port having a predetermined configuration;
a contact support member housed at least partially within the housing, wherein the contact support member extends forwardly toward the port;
a plurality of first contacts mounted on the contact support member, wherein each of the plurality of first contacts is configured to electrically connect with the associated connector along a first plane parallel to a plane of insertion for the associated connector into the port; and
at least one second contact mounted on the contact support member, wherein the at least one second contact is configured to electrically connect with the associated connector along a second plane perpendicular to the plane of insertion for the associated connector into the port, wherein the at least one second contact has a population of second contacts that is greater than a population of the plurality of first contacts.

5. An electrical connector comprising:
a housing for receiving an associated connector; wherein the housing includes at least one wall that defines a port having a predetermined configuration;
a contact support member housed at least partially within the housing, wherein the contact support member extends forwardly toward the port;
a plurality of first contacts mounted on the contact support member, wherein each of the plurality of first contacts is configured to electrically connect with the associated connector along a first plane parallel to a plane of insertion for the associated connector into the port; and
at least one second contact mounted on the contact support member, wherein the at least one second contact is configured to electrically connect with the associated connector along a second plane perpendicular to the plane of insertion for the associated connector into the port, wherein the at least one second contact has a plurality of second contacts having a population of second contacts less then a population of the plurality of first contacts.

6. The electrical connector of claim 2, wherein the plurality of first contacts include a contact for a data + signal contact, a data − signal contact, a ground signal contact and a +5 Volt signal contact.

7. The electrical connector of claim 6, wherein the at least one second contact include at least one audio signal contact for outputting an analog audio signal to an associated accessory.

8. The electrical connector of claim 6, wherein the at least one second contact includes at least one power signal contact for outputting a power signal to an associated accessory.

9. The electrical connector of claim 2, wherein the port is configured to receive at least a universal serial bus (USB) connector having a form factor consisting of at least one of a standard USB connector, a mini-USB connector or a micro-USB connector.

10. The electrical connector of claim 2, wherein at least one contact from the plurality of first contacts and/or the at least one second contacts is formed in the contact support member.

11. An electrical connector comprising:
an interface housing adapted to be inserted into an associated receiving connector; wherein the interface housing includes at least one wall that defines a port having a predetermined configuration;
a first contact support member housed at least partially within the interface housing, wherein the first contact support member extends forwardly toward the port;
a plurality of first contacts mounted on the first contact support member, wherein each of the plurality of first contacts is configured to electrically connect with the associated connector along a plane parallel to a plane of insertion of the interface housing into the associated receiving connector the port; and
at least one second contact mounted within the interface housing, wherein the at least one second contact is configured to electrically connect with the associated connector along a second plane perpendicular to the axis of insertion of the interface housing into the associated receiving connector, wherein the plurality of first contacts are electrically isolated from the at least one second contact.

12. The electrical connector of claim 11 further including an accessory housing secured to the interface housing, wherein the accessory housing includes accessory circuitry for performing a communication function.

13. An electrical connector comprising:
an interface housing adapted to be inserted into an associated receiving connector; wherein the interface housing includes at least one wall that defines a port having a predetermined configuration;
a first contact support member housed at least partially within the interface housing, wherein the first contact support member extends forwardly toward the port; a plurality of first contacts mounted on the first contact support member, wherein each of the plurality of first contacts is configured to electrically connect with the associated connector along a plane parallel to a plane of insertion of the interface housing into the associated receiving connector the port;
at least one second contact mounted within the interface housing, wherein the at least one second contact is configured to electrically connect with the associated connector along a second plane perpendicular to the axis of insertion of the interface housing into the associated receiving connector;
an accessory housing secured to the interface housing, wherein the accessory housing includes accessory circuitry for performing a communication function; and a printed circuit board for coupling the plurality of first contacts and the at least one second contact to accessory circuitry housed at least partially within the accessory housing.

14. The electrical connector of claim 13 further including an elastic member coupled between the at least one second contact and the printed circuit board to allow the at least one second contact to extend and/or retract within the interface housing.

15. The electrical connector of claim 14, where the elastic member is a spring.

16. An electrical connector comprising:
an interface housing adapted to be inserted into an associated receiving connector; wherein the interface housing includes at least one wall that defines a port having a predetermined configuration;
a first contact support member housed at least partially within the interface housing, wherein the first contact support member extends forwardly toward the port; a plurality of first contacts mounted on the first contact support member, wherein each of the plurality of first contacts is configured to electrically connect with the associated connector along a plane parallel to a plane of insertion of the interface housing into the associated receiving connector the port;
at least one second contact mounted within the interface housing, wherein the at least one second contact is configured to electrically connect with the associated connector along a second plane perpendicular to the axis of insertion of the interface housing into the associated receiving connector;
an accessory housing secured to the interface housing, wherein the accessory housing includes accessory circuitry for performing a communication function, wherein the plurality of first contacts and the at least one second contact include one end secured on the printed circuit board independently of one another.

17. An electrical connector comprising:
an interface housing adapted to be inserted into an associated receiving connector; wherein the interface housing includes at least one wall that defines a port having a predetermined configuration;
a first contact support member housed at least partially within the interface housing, wherein the first contact support member extends forwardly toward the port; a plurality of first contacts mounted on the first contact support member, wherein each of the plurality of first contacts is configured to electrically connect with the associated connector along a plane parallel to a plane of insertion of the interface housing into the associated receiving connector the port; and
at least one second contact mounted within the interface housing, wherein the at least one second contact is configured to electrically connect with the associated connector along a second plane perpendicular to the axis of insertion of the interface housing into the associated receiving connector, wherein the at least one second contact has a population of second contacts that is greater than a population of the plurality of first contacts.

18. An electrical connector comprising:
an interface housing adapted to be inserted into an associated receiving connector; wherein the interface housing includes at least one wall that defines a port having a predetermined configuration;
a first contact support member housed at least partially within the interface housing, wherein the first contact support member extends forwardly toward the port; a plurality of first contacts mounted on the first contact support member, wherein each of the plurality of first contacts is configured to electrically connect with the associated connector along a plane parallel to a plane of insertion of the interface housing into the associated receiving connector the port; and
at least one second contact mounted within the interface housing, wherein the at least one second contact is configured to electrically connect with the associated connector along a second plane perpendicular to the axis of insertion of the interface housing into the associated receiving connector, wherein the at least one second contact has a population of second contacts that is less than a population of the plurality of first contacts.

19. The electrical connector of claim 16, wherein the plurality of first contacts include a contact for a data + signal contact, a data − signal contact, a ground signal contact and a +5 Volt signal contact.

20. The electrical connector of claim 16, wherein the port is configured to be inserted into a universal serial bus (USB) connector having a form factor consisting of at least one of a standard USB connector, a mini-USB connector or a micro-USB connector.

21. A mobile telephone comprising:
a housing;
communication circuitry for receiving and/or transmitting telephone calls over a mobile telephony network housed within the housing;
an electrical connector including a housing for receiving an associated connector; wherein the housing includes at least one wall that defines a port having a predetermined configuration;
a contact support member housed at least partially within the housing, wherein the contact support member extends forwardly toward the port;
a plurality of first contacts mounted on the contact support member, wherein each of the plurality of first contacts is configured to electrically connect with the associated connector along a first plane parallel to a plane of insertion for the associated connector into the port; and
at least one second contact mounted on the contact support member, wherein the at least one second contact is configured to electrically connect with the associated connector along a second plane perpendicular to the plane of insertion for the associated connector into the port, wherein the electrical connector is housed within at least a portion of the housing, wherein the port is capable of receiving a connector from the associated accessory; and
control circuitry coupled to communication circuitry and the electrical connector to control operation of the communication circuitry and the electrical connector to perform one more functions.
